(19) United States
(12) Patent Application Publication
(10) Pub. No.: US 2017/0157747 A1
(43) Pub. Date: Jun. 8, 2017

(54) HAND TOOL

(71) Applicants: HANGZHOU GREAT STAR TOOLS CO., LTD., Hangzhou City (CN); HANGZHOU GREAT STAR INDUSTRIAL CO., LTD., Hangzhou City (CN)

(72) Inventor: Min Wang, Hangzhou City (CN)

(21) Appl. No.: 15/325,607

(22) PCT Filed: Jul. 11, 2014
(86) PCT No.: PCT/CN2014/082040

§ 371 Date: Jan. 11, 2017

(51) Int. Cl. B25B 7/10; B26B 13/28

(52) U.S. Cl. CPC B25B 7/10; B26B 13/28

(57) ABSTRACT

The invention discloses a single-shaft hand tool, which comprises a first body and a second body. Wherein the first body is provided with a groove, the second body is provided with a protrusion, the protrusion is mounted within the groove in a nested manner, thus enabling the first body to be pivotally connected to the second body by means of a virtual pivot. The invention also discloses a double-shaft hand tool, which comprises a first body and a second body. The first body is pivotally connected to the second body by means of a virtual pivot. The first body is provided with a third groove and a first hole, the second body is provided with a fourth groove and a second hole. A first fastener passes through the first hole and the fourth groove. Meanwhile, a second fastener passes through the second hole and the third groove. Therefore, the first body is fixedly connected to the second body in the direction parallel to the axis of the virtual pivot.

### FIELD OF THE INVENTION

The invention relates to a hand tool.

### DESCRIPTION OF THE PRIOR ART

Existing hand tools, such as pliers, usually comprises a left handle and a right handle, on the top of which is arranged a left jaw and a right jaw respectively. The left jaw and the right jaw are connected by means of a pivot. In use, by operating the left handle and the right handle, the left jaw and the right jaw are clamped to each other, thus realizing the clamping function of the pliers. Existing scissors usually have the same structure, too. It is laborious to use pliers or scissors of this structure

### SUMMARY OF THE INVENTION

Given the above disadvantage of the prior art, the objective of the present solution to the technical problem is to provide a hand tool used for holding, cutting, pressing, clamping, etc., which is labor-saving, durable and easy to operate.

To achieve the above objects, the invention provides a single-shaft hand tool, which comprises a first body and a second body. The first body is provided with a protrusion, the second body is provided with a groove. The protrusion is mounted within the groove in a nested manner, thus enabling the first body to be pivotally connected to the second body by means of a virtual pivot, and the protrusion can slide in the groove around the virtual pivot under the guidance of the groove.

Preferably, the first body has a first working part. The second body has a second working part. The first working part and the second working part are matched to form a work area.

Preferably, the first body has a first handle, the second body has a second handle which cooperates with the first handle, when a force is applied to the first handle in a first direction, the protrusion slides relative to the groove around the virtual pivot in the first direction, thus making the first handle and the second handle move apart from each other, meanwhile making the first working part and the second working part move apart from each other; when a force is applied to the first handle in a second direction, the protrusion slides relative to the groove around the virtual pivot in the second direction, thus making the first handle and the second handle move close to each other, meanwhile making the first working part and the second working part move close to each other. The first direction and the second direction are in the opposite direction to each other.

Preferably, the working area has a starting position and an ending position. The starting position is closer to the groove or the protrusion than the ending position.

Preferably, the virtual pivot is at the starting position of the work area.

Preferably, the groove extends in the shape of a circular arc.

Preferably, the protrusion extends in the shape of a circular arc and is concentric with the groove.

Preferably, the first body and the second body are both provided with blocking portion which prevents the protrusion from sliding out of the groove.

Preferably, the first body is further provided with a circular hole throughout the first body in the thickness direction thereof, and the second body is provided with a circular arc hole through the groove. The circular arc hole extends in the shape of a circular arc, and is concentric with the groove. A fastener is arranged in the hole, which passes through the circular arc hole, enabling the first body to be fixedly connected to the second body in the direction parallel to the axis of the virtual pivot. When the protrusion slides in the groove around the virtual pivot under the guidance of the groove, the fastener can slide in the arc slot around the virtual pivot under the guidance of the arc slot.

In the single-shaft hand tool of the invention, the virtual pivot is a non-material pivot, i.e. an imaginary pivot. When the protrusion slides in the groove, the single-shaft hand tool has a fixed axis, of which the shaft is the virtual pivot.

The invention also provides another single-shaft hand tool, which a first body and a second body, wherein the first body is provided with a first groove, the second body is provided with a second groove, the single-shaft hand tool further comprises a protrusion, of which the two ends are inlaid into the first groove and the second groove respectively, thus enabling the first body to be pivotally connected to the second body by means of a virtual pivot, and the protrusion can slide in the second groove around the virtual pivot under the guidance of the second groove.

Preferably, the first body has a first working part, the second body has a second working part, and the first working part and the second working part are matched to form a working area.

Preferably, the first body has a first handle, the second body has a second handle which cooperates with the first handle, when a force is applied to the first handle in a first direction, the protrusion slides relative to the second groove around the virtual pivot in the first direction, thus making the first handle and the second handle move apart from each other, meanwhile making the first working part and the second working part move apart from each other; when a force is applied to the first handle in a second direction, the protrusion slides relative to the second groove around the virtual pivot in the second direction, thus making the first handle and the second handle move close to each other, meanwhile making the first working part and the second working part move close to each other; the first direction and the second direction are in the opposite direction to each other.

Preferably, the working area has a starting position and an ending position, the starting position is closer to the first groove, the second groove or the protrusion than the ending position, the virtual pivot is at the starting position of the working area.

Preferably, the first groove, the second groove and the protrusion all extend in the shape of a circular arc, and the protrusion, the first groove and the second groove are concentric when overlaid with one another.

Preferably, the first body is further provided with a first circular hole through the first groove; the second body is provided with a circular arc hole is formed in through the second groove, the circular arc hole extends in the shape of a circular arc, and is concentric with the first groove; the protrusion is provided with a second circular hole; a fastener is arranged in the first circular hole, which passes through the second circular hole and the circular arc hole, enabling the first body to be fixedly connected to the second body in the direction parallel to the axis of the virtual pivot.

In another single-shaft hand tool of the invention, the protrusion is independent of the first body and the second body, and therefore would help to improve the accuracy of manufacture and cooperation. Besides, the virtual pivot is a non-material pivot, i.e. an imaginary pivot. When the protrusion slides in the first groove, the single-shaft hand tool has a fixed axis, of which the shaft is the virtual pivot.

The invention also provides a double-shaft hand tool, which comprises a first body and a second body. The first body is pivotally connected to the second body by means of a virtual pivot, the first body is provided with a third groove and a first hole, the second body is provided with a fourth groove and a second hole. A first fastener passes through the first hole and the fourth groove, meanwhile, a second fastener passes through the second hole and the third groove. Therefore, the first body is fixedly connected to the second body in the direction parallel to the axis of the virtual pivot.

Preferably, the first body has a first working part, the second body has a second working part, and the first working part and the second working part are matched to form a work area.

Preferably, the first body has a first handle. The second body has a second handle which cooperates with the first handle, when a force is applied to the first handle in a first direction, the first fastener slides in the fourth groove around the virtual pivot in the first direction, meanwhile the second fastener slides in the third groove around the virtual pivot in a direction opposite to the first direction, thus making the first handle and the second handle move apart from each other, meanwhile making the first working part and the second working part move apart from each other.

Preferably, when a force is applied to the first handle in a second direction, the first fastener slides in the fourth groove around the virtual pivot in the second direction, meanwhile the second fastener slides in the third groove around the virtual pivot in a direction opposite to the second direction, thus making the first handle and the second handle move close to each other; meanwhile making the first working part and the second working part move close to each other.

Preferably, the first direction and the second direction are in the opposite direction to each other.

Preferably, the first handle and the second handle are both arranged to be ring-shaped.

Preferably, the working area has a starting position and an ending position. The starting position is closer to the third groove or the fourth groove than the ending position.

Preferably, the virtual pivot is at the starting position of the work area.

Preferably, the third groove and the fourth groove both extend in the shape of a circular arc, and the third groove and the fourth groove are concentric when overlaid with each other.

In the double-shaft hand tool of the invention, the virtual pivot is a non-material pivot, i.e. an imaginary pivot. When the first fastener and the second fastener slide within the fourth groove and the third groove respectively, the double-shaft hand tool has a fixed axis, of which the shaft is the virtual pivot.

The nested structure of the protrusion and the groove in the single-shaft hand tool of the invention may also be applied in the double-shaft hand tool.

The single-shaft or double-shaft hand tool of the invention has the following advantages:

(1) The single-shaft or double-shaft hand tool of the invention may be labor-saving pliers or labor-saving scissors, which have such functions as holding, cutting, pressing, clamping, etc.

(2) Whether in the single-shaft hand tool or in the double-shaft hand tool, the first body is pivotally connected to the second body by means of a virtual pivot which is at the starting position of the work area. Therefore, compared with the pivot of existing pliers or scissors, the virtual pivot of the hand tool of the invention is closer to the jaws or the blades, thus making the hand tool labor-saving.

(3) When holding, cutting, pressing or clamping things by applying force to the single-shaft hand tool of the invention, the groove is not easy to wear and tear, because the protrusion which is mounted within the groove in a nested manner has relative large surface. Therefore, the durability of the hand tool is increased.

The purposes, features and effects of the invention can be fully understood through the further description of the conception, detailed structures and technical effects of the invention with reference to the accompanying drawings hereinafter, in which:

### BRIEF DESCRIPTION OF THE DRAWINGS

FIG. 1 is a front view of the hand tool in a first embodiment of the invention;

FIG. 2 is a rear view of the hand tool shown in FIG. 1;

FIG. 3 is an assembly graph of the hand tool shown in FIG. 1;

FIG. 4 is a schematic view of the first body of the hand tool shown in FIG. 1;

FIG. 5 is a schematic view of the second body of the hand tool shown in FIG. 1;

FIG. 6 is a front view of the hand tool in a second embodiment of the invention;

FIG. 7 is a rear view of the hand tool shown in FIG. 6;

FIG. 8 is an assembly graph of the hand tool shown in FIG. 6;

FIG. 9 is a schematic view of the hand tool in a third embodiment of the invention;

FIG. 10 is another schematic view of the hand tool in a third embodiment of the invention;

FIG. 11 is an assembly graph of the hand tool shown in FIG. 9;

FIG. 12 is an assembly graph of the hand tool shown in FIG. 10.

### DETAILED DESCRIPTION OF THE PREFERRED EMBODIMENTS

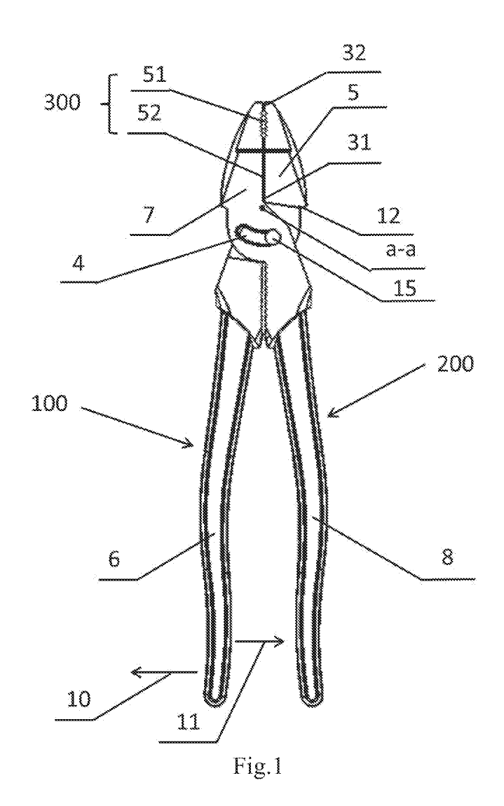

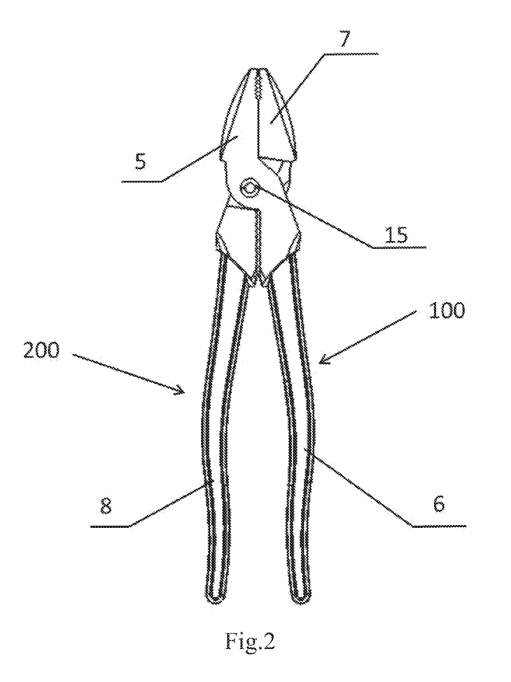

As shown in FIG. 1-3, the hand tool according to the first embodiment of the invention includes a first body 100 and a second body 200. The first body 100 is provided with a protrusion 4 body. The second body 200 is provided with a groove 3 body. The protrusion 4 is mounted within the groove 3 in a nested manner, thus enabling the first body 100 to be pivotally connected to the second body 200 by means of a virtual pivot a-a. Besides, the first body 100 has a first working part 5 and a first handle 6. Accordingly, the second body 200 has a second working part 7 and a second handle 8 which cooperates with the first handle 6. The first working part 5 and the second working part 7 are matched to form a working area 300. The working area 300 has a starting position 31 and an ending position 32. As can be seen from FIG. 1, the starting position 31 is closer to the groove 3 or the protrusion 4 than the ending position 32. The area between the starting position 31 and the ending position 32 forms the whole working area 300.

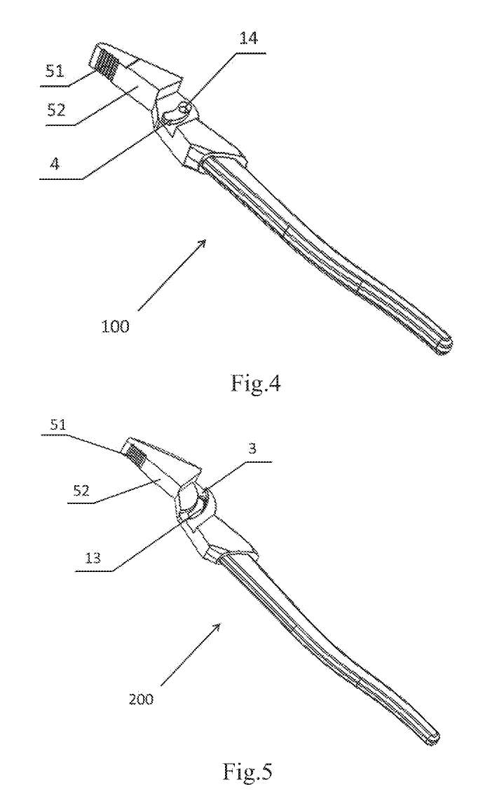

According to the embodiment, the hand tool is a single-shaft hand tool, specifically labor-saving single-shaft pliers, which depends on the structure of the working area 300 formed by the first working part 5 and the second working part 7. As shown in FIG. 1, FIG. 4 and FIG. 5, the first working part 5 and the second working part 7 both have two parts: a first clamping part 51 and a second clamping part 52. Arranged with teeth, the first clamping part 51 can clamp and press a workpiece. The teeth increase the friction between the first clamping part 51 and the workpiece. According to the embodiment, the second clamping part 52 has flat surface, which may also be arranged to be blades in other embodiments for cutting a workpiece. The single-shaft hand tool of other embodiments may also be labor-saving single-shaft scissors. As long as the first working part 5 and the second working part 7 are arranged to be blades, the working area 300 is the scissors mouth formed by two blades, which can cut a workpiece.

According to the embodiment, the virtual pivot a-a is a non-material pivot, i.e. an imaginary pivot. When the protrusion 4 slides in the groove 3, the single-shaft hand tool has a fixed axis, which is at or near the starting position 31. The shaft of the axis is the virtual pivot a-a. Compared with the pivot of existing pliers, the virtual pivot a-a is closer to the working area 300. According to lever principle, as long as a little force applied to the handles, greater clamping force will be generated in the working area 300, so as to achieve the purpose of labor saving.

According to the embodiment, the virtual pivot a-a is formed when the protrusion 4 nesting in the groove 3. When the protrusion 4 is nested in the groove 3, the first body 100 and the second body 200 are movably connected together. The protrusion 4 is slidable in the groove 3, enabling the first body 100 and the second body 200 to pivot around the virtual pivot a-a, i.e., the first body 100 and the second body 200 can be seen as being pivotally connected by means of the virtual pivot a-a. In operation, when the user applies force to the first handle 6 in a first direction 10 as shown in FIG. 1, the first handle 6 passes the force to the protrusion 4, making the protrusion 4 slide relative to the groove 3 around the virtual pivot a-a in the first direction 10. Therefore, the first handle 6 moves apart from the second handle 8, meanwhile the first working part 5 moves apart from the second working part 7, then the jaws open. Here the jaws are the working area 300. On the contrary, when the user applies force to the first handle 6 in a second direction 11, the first handle 6 passes the force to the protrusion 4, making the protrusion 4 slide relative to the groove 3 around the virtual pivot a-a in the second direction 11. Therefore, the first handle 6 moves close to the second handle 8, meanwhile the first working part 5 moves close to the second working part 7, then the jaws close. As can be seen from the drawings, the first direction 10 is opposite to the second direction 11 are opposite.

To prevent the protrusion 4 from sliding out of the groove 3, the first body 100 and the second body 200 are both provided with blocking portion 12. In that way, when the jaws open, the first handle 6 and the second handle 8 keep moving apart from each other until the ends of the two handles are contacted with the blocking portion 12 and subjected to resistant effect of the blocking portion 12, then the first handle 6 and the second handle 8 stop moving apart from each other, and the protrusion 4 is kept in the groove 3.

As shown in FIG. 4, the protrusion 4 extends in the shape of a circular arc. As shown in FIG. 5, the groove 3 also extends in the shape of a circular arc along the width of the second body 200. The depth of the groove 3 is less than the thickness of the second body 200. The arc where the protrusion 4 lies is concentric with the groove 3, enabling the protrusion 4 to slide freely in the groove 3 around the virtual pivot a-a.

Therefore, the jaws of the hand tool according to the embodiment can open and close freely.

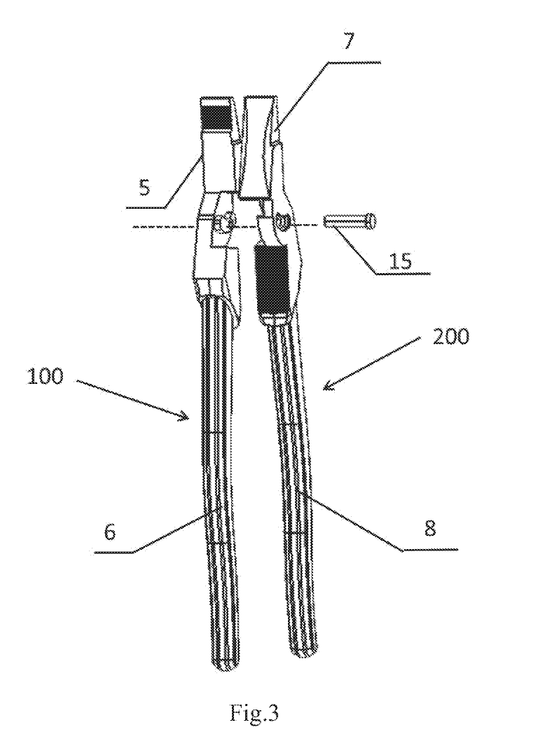

As shown in FIG. 4 and FIG. 5, the first body 100 is further provided with a circular hole 14 throughout the first body in the thickness direction thereof, the second body 200 is provide with a circular arc hole 13 body through the groove 3. The circular arc hole 13 extends in the shape of a circular arc, and is concentric with the groove 3. A fastener 15 is arranged in the circular hole 14 (referring to FIG. 1 and FIG. 3), which passes through the circular arc hole 13, enabling the first body 100 to be fixedly connected to the second body 200 in the direction paralleling the axis of the virtual pivot a-a. When the protrusion 4 slides in the groove 3 around the virtual pivot a-a under the guidance of the groove 3, the fastener 15 can slide in the circular arc hole 13 around the virtual pivot a-a under the guidance of the circular arc hole 13.

According to the embodiment, the fastener 15 can either be a rivet and a cotter, or fastening elements comprising a bolt and a nut.

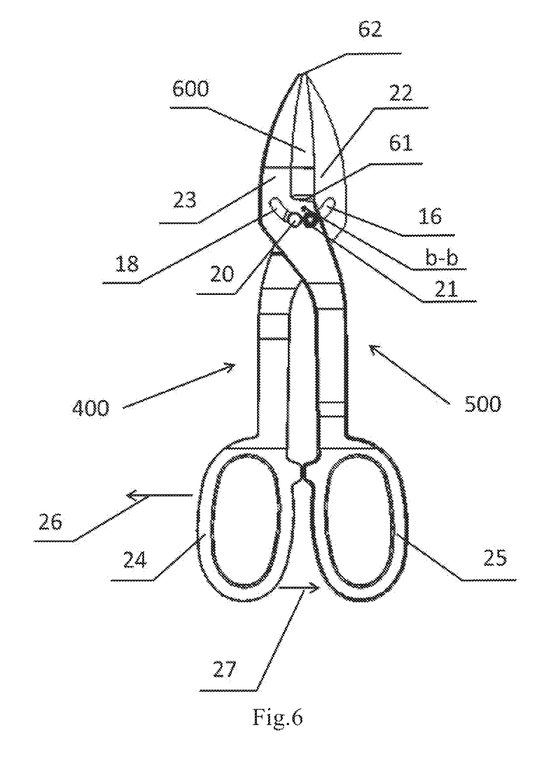

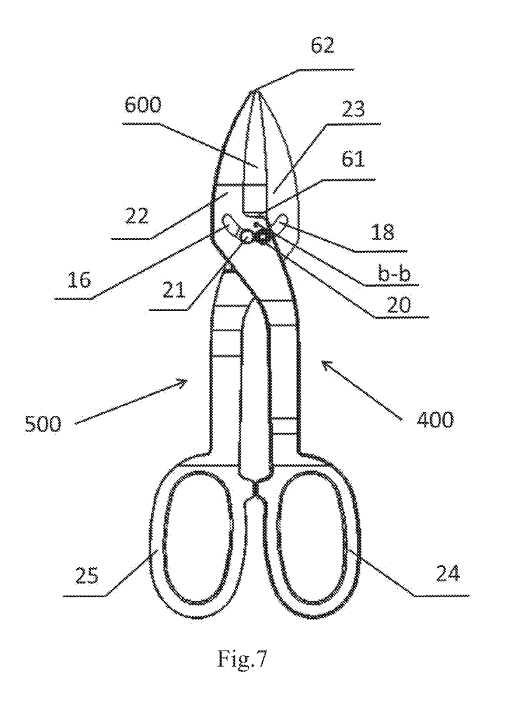

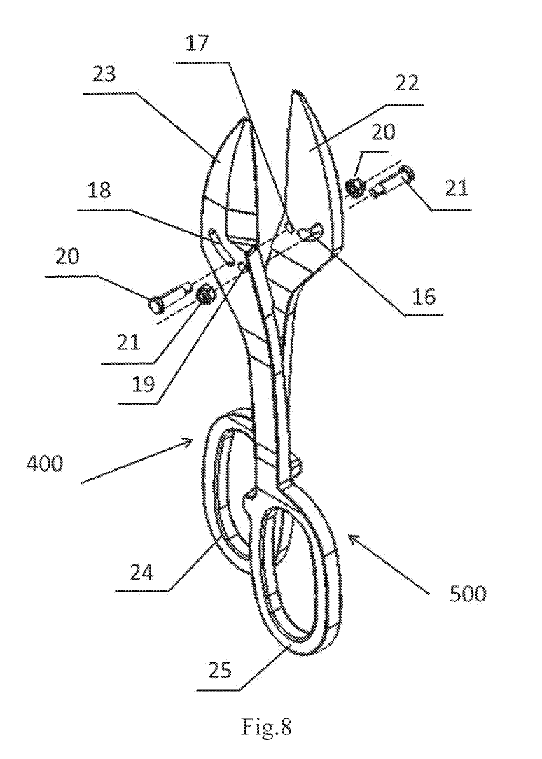

A second embodiment of the invention is shown in FIG. 6-8. According to the embodiment, a hand tool, specifically a double-shaft hand tool is provided, which comprises a first body 400 and a second body 500. The first body 400 is pivotally connected to the second body 500 by means of a virtual pivot b-b. The first body 400 is provided with a third groove 16 and a first hole 17, the second body 500 is provided with a fourth groove 18 and a second hold 19. A first fastener 20 passes through the first hole 17 and the fourth groove 18, meanwhile a second fastener 21 passes through the second hole 19 and the third groove 16. Therefore, the first body 400 is fixedly connected to the second body 500 in the direction parallel to the axis of the virtual pivot b-b.

According to the embodiment, the virtual pivot b-b is also a non-material pivot, i.e. an imaginary pivot, which is formed when the first body 400 and the second body 500 are movably connected together by the first fastener 20 and the second fastener 21. After the first body 400 is connected to the second body 500 by the first fastener 20 and the second fastener 21, the first fastener 20 and the second fastener 21 can slide in the fourth groove 18 and the third groove 16 respectively, enabling the first body 400 and the second body 500 to pivot around the virtual pivot b-b, i.e., the first body 400 and the second body 500 can be seen as being pivotally connected by means of the virtual pivot b-b.

In the double-shaft hand tool of the embodiment, the first body 400 has a first working part 22 and a first handle 24. The second body 500 has a second working part 23 and a second handle 25 which cooperates with the first handle 24. The first working part 22 and the second working part 23 are matched to form a working area 600. The working area 600 has a starting position 61 and an ending position 62. As can be seen from FIG. 6, the starting position 61 is closer to the third groove 16 or the fourth groove 18 than the ending position 62. The area between the starting position 61 and the ending position 62 forms the whole working area 600. According to the embodiment, the first working part 22 and the second working part 23 are both arranged to be blades. The working area 600 is formed by two blades, which may be used to cut a workpiece. Therefore the double-shaft hand tool of the embodiment may specifically be labor-saving double-shaft scissors. In other embodiments, the first working part 22 and the second working part 23 may also be arranged to be jaws for clamping, then the double-shaft hand tool is labor-saving double-shaft pliers.

In operation, when the user applies force to the first handle 24 in a first direction 26, the first fastener 20 slides in the fourth groove 18 around the virtual pivot b-b in the first direction 26, meanwhile the second fastener 21 slides in the third groove 16 around the virtual pivot b-b in a direction opposite to the first direction 26. Thus the first handle 24 and the second handle 25 move apart from each other, meanwhile the first working part 22 and the second working part 23 move apart from each other, then the blades open. When the user applies force to the first handle 24 in a second direction 27, the first fastener 20 slides within the fourth groove 18 around the virtual pivot b-b in the second direction 27, meanwhile the second fastener 21 slides in the third groove 16 around the virtual pivot b-b in a direction opposite to the second direction 27. Thus the first handle 24 and the second handle 25 move close to each other, meanwhile the first working part 22 and the second working part 23 move close to each other, then the blades close. Referring to FIG. 6, the first direction 26 and the second direction 27 are in the opposite direction to each other.

In the labor-saving double-shaft scissors of the invention, the virtual pivot b-b is at or near the starting position 61. Compared with the pivot of existing scissors, the virtual pivot b-b is closer to the working area 600. According to lever principle, as long as a little force applied to the handles, greater cutting force will be generated in the working area 600, so as to achieve the purpose of labor saving.

According to the embodiment, the first handle 24 and the second handle 25 are arranged to be ring-shaped. In that way, in use, the use may put his fingers into one of the ring-shaped handles and hold the two handles. By operating the two handles, relative movement is produced between the handles, which brings the cutting function of the working area 600.

According to the embodiment, the third groove 16 and the fourth groove 18 both extend in the shape of a circular arc, and the third groove 16 and the fourth groove 18 are concentric when overlaid with each other. The first fastener 20 and the second fastener 21 may slide freely in the fourth groove 18 and the third groove 16 respectively, enabling the blades to open or close freely.

According to the embodiment, the first fastener 20 and the second fastener 21 can either be rivets and cotters, or fastening members comprising bolts and nuts.

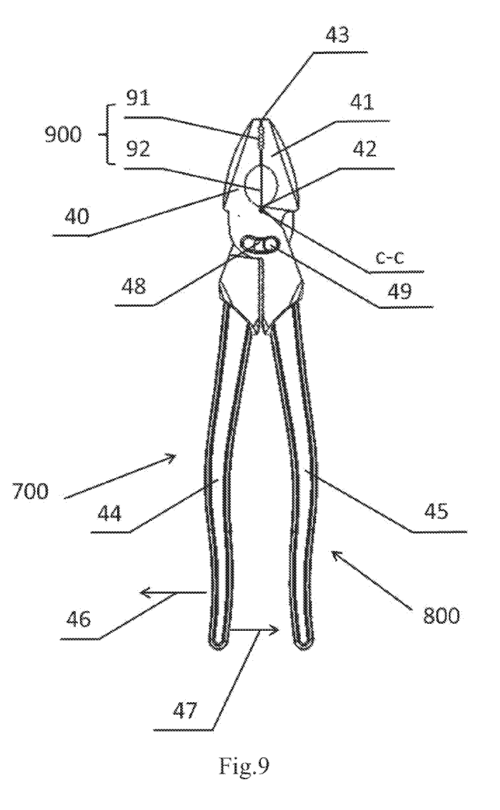

A third embodiment of the invention is shown in FIG. 9-12, which provides another single-shaft hand tool, comprising a first body 700 and a second body 800. The first body 700 is provided with a first groove 37. The second body 800 is provided with a second groove 38. The single-shaft hand tool of the embodiment also includes a protrusion 48, of which the two ends are inlaid into the first groove 37 and the second groove 38 respectively, thus enabling the first body 700 to be pivotally connected to the second body 800 by means of a virtual pivot c-c. The protrusion 48 can slide in the second groove 38 around the virtual pivot c-c under the guidance of the first groove 37. Besides, the first body 700 also has a first working part 41 and a first handle 44. Accordingly, the second body 800 has a second working part 40 and a second handle 45 which cooperates with the first handle 44. The first working part 41 and the second working part 40 are matched to form a working area 900. The working area 900 has a starting position 42 and an ending position 43. The starting position 42 is closer to the first groove 37, the second groove 38 or the protrusion 48 than the ending position 43. The area between the starting position 42 and the ending position 43 forms the whole working area 900.

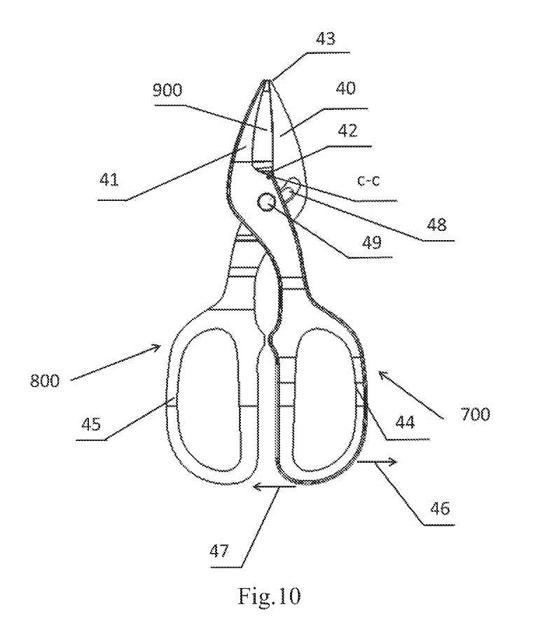

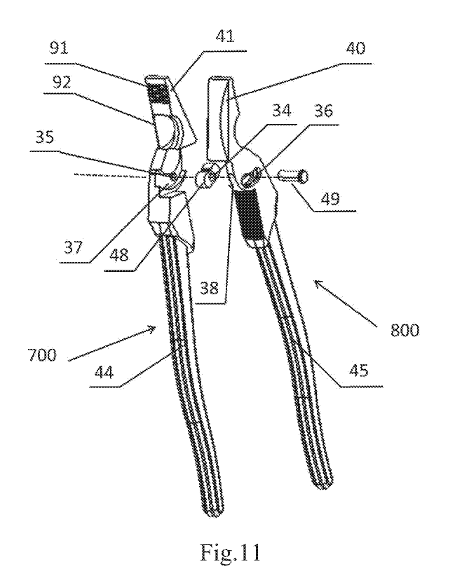

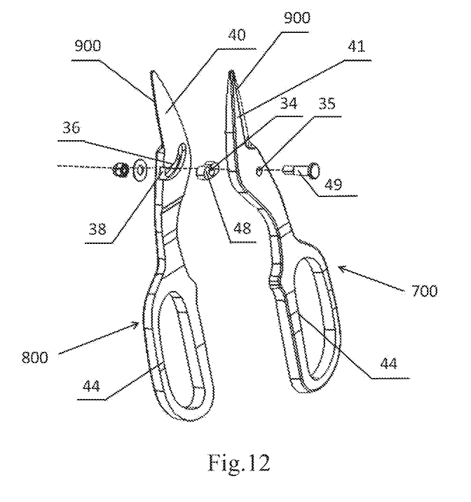

According to the embodiment, the single-hand hand tool may be labor-saving single-shaft pliers (referring to FIG. 9 and FIG. 11), or labor-saving single-hand scissors (referring to FIG. 10 and FIG. 12), which depends on the structure of the working area 900 formed by the first working part 41 and the second working part 40. As shown in FIG. 9 and FIG. 10, both the first working part 41 and the second working part 40 include two parts: the first clamping part 91 and the second clamping part 92. Arranged with teeth, the first clamping part 91 can clamp and press a workpiece. The teeth increase the friction between the first clamping part 91 and the workpiece. According to the embodiment, the second clamping part 92 is arranged to be blades for cutting a workpiece. While in FIG. 10 and FIG. 12, the first working part 41 and the second working part 40 are both arranged to be blades, the working area 900 is the scissors mouth formed by two blades, which can cut a workpiece.

As shown in FIG. 11 and FIG. 12, in the first body 700 is also provided with a first circular hole 35 through the first groove 37. The second body 800 is provided with a circular arc hole 36 through the second groove 38. The circular arc hole 36 extends in the shape of a circular arc and is concentric with the first groove 37. The protrusion 48 is provided with a second circular hole 34. A fastener 49 is arranged in the first circular hole 35d, which passes through the second circular hole 34 and the circular arc hole 36, enabling the first body 700 to be fixedly connected to the second body 800 in the direction paralleling the axis of the virtual pivot c-c. When the protrusion 48 slides in the second groove 38 around the virtual pivot c-c under the guidance of the second groove 38, the fastener 49 can slide in the circular arc hole 36 around the virtual pivot c-c under the guidance of the circular arc hole 36.

As shown in FIG. 11 and FIG. 12, the first groove 37 extends in the shape of a circular arc along the width of the first body 700. The depth of the first groove 37 is less than the thickness of the first body 700. Similarly, the second groove 38 extends in the shape of a circular arc along the width of the second body 800. The depth of the second groove 38 is less than the thickness of the second body 800. The protrusion 48 also extends in the shape of a circular arc, and the circular arc where the protrusion 48 lies is concentric with the first groove 37 and the second groove 38, enabling the protrusion 48 to slide freely in the second groove 38 around the virtual pivot c-c. Therefore, the jaws or blades of the hand tool according to the embodiment can open and close freely.

According to the embodiment, the virtual pivot c-c is a non-material pivot, i.e. an imaginary pivot. When the protrusion 48 slides in the first groove 37, the single-shaft hand tool has a fixed axis, which is at or near the starting position 42. The shaft of the axis is the virtual pivot c-c. Compared with the pivot of existing pliers, the virtual pivot c-c is closer to the working area 900. According to lever principle, as long as a little force applied to the handles, greater clamping force will be generated in the working area 900, so as to achieve the purpose of labor saving.

According to the embodiment, the virtual pivot c-c is formed when the two ends of the protrusion 48 are inlaid into the first groove 37 and the second groove 38 respectively. When the first groove 37, the second groove 38 and the protrusion 48 are inlaid together, the first body 700 and the second body 800 are movably connected together. The protrusion 48 can slide in the second groove 38, enabling the first body 700 and the second body 800 to pivot around the virtual pivot c-c, i.e., the first body 700 and the second body 800 can be seen as being pivotally connected by means of the virtual pivot c-c. In operation, when the user applies force to the first handle 44 in a first direction 46 as shown in FIG. 1, the first handle 44 passes the force to the protrusion 48, making the protrusion 48 slide relative to the second groove 38 around the virtual pivot c-c in the first direction 46. Thus the first handle 44 will move apart from the second handle 45, meanwhile the first working part 41 will move apart from the second working part 40, and then the jaws or blades open. Here the jaws or blades are the work area. On the contrary, when the user applies force to the first handle 44 in a second direction 47, the first handle 44 passes the force to the protrusion 48, making the protrusion 48 slide relative to the second groove 38 around the virtual pivot c-c in the second direction 47. Thus the first handle 44 will move close to the second handle 45, meanwhile the first working part 41 will move close to the second working part 40, and then the jaws or blades close. As shown in the drawings, the first direction 46 and the second direction 47 are in the opposite direction to each other.

The single-shaft hand tool of the embodiment is different from the single-shaft hand tool of the first embodiment in that the protrusion 48 is independent of the first body 700 and the second body 800, which is good for follow-up manufacture and the accuracy of the protrusion 48 cooperating with the first groove 37 and the second groove 38.

According to the embodiment, the fastener can either be a rivet and a cotter, or fastening members comprising a bolt and a nut.

The preferably embodiments of the invention are described in details above. What stated above are merely preferred embodiments of the present invention. Any modification, equivalent replacement and improvement made to the present invention shall be within the scope of the appended claims.

1. A single-shaft hand tool, comprising a first body and a second body, characterized in that the first body is provided with a protrusion, the second body is provided with a groove, the protrusion is mounted within the groove in a nested manner, thus enabling the first body to be pivotally connected to the second body by means of a virtual pivot, and the protrusion can slide in the groove around the virtual pivot under the guidance of the groove.

2. The single-shaft hand tool according to claim 1, wherein the first body has a first working part, the second body has a second working part, and the first working part and the second working part are matched to form a working area.

3. The single-shaft hand tool according to claim 2, wherein the first body has a first handle, the second body has a second handle which cooperates with the first handle, when a force is applied to the first handle in a first direction, the protrusion slides relative to the groove around the virtual pivot in the first direction, thus making the first handle and the second handle move apart from each other, meanwhile making the first working part and the second working part move apart from each other; when a force is applied to the first handle in a second direction, the protrusion slides relative to the groove around the virtual pivot in the second direction, thus making the first handle and the second handle move close to each other, meanwhile making the first working part and the second working part move close to each other; the first direction and the second direction are in the opposite direction to each other.

4. The single-shaft hand tool according to claim 2, wherein the working area has a starting position and an ending position, the starting position is closer to the groove or the protrusion than the ending position, the virtual pivot is at the starting position of the working area.

5. The single-shaft hand tool according to claim 1, wherein the groove and the protrusion both extend in the shape of a circular arc, and the protrusion is concentric with the groove.

6. The single-shaft hand tool according to claim 1, wherein the first body is further provided with a circular hole throughout the first body in the thickness direction thereof, and the second body is provided with a circular arc hole through the groove, the circular arc hole extends in the shape of a circular arc, and is concentric with the groove; a fastener is arranged in the circular hole, which passes through the circular arc hole, enabling the first body to be fixedly connected to the second body in the direction parallel to the axis of the virtual pivot.

7. A single-shaft hand tool, comprising a first body and a second body, wherein the first body is provided with a first groove, the second body is provided with a second groove, the single-shaft hand tool further comprises a protrusion, of which the two ends are inlaid into the first groove and the second groove respectively, thus enabling the first body to be pivotally connected to the second body by means of a virtual pivot, and the protrusion can slide in the second groove around the virtual pivot under the guidance of the second groove.

8. The single-shaft hand tool according to claim 7, wherein the first body has a first working part, the second body has a second working part, and the first working part and the second working part are matched to form a working area.

9. The single-shaft hand tool according to claim 8, wherein the first body has a first handle, the second body has a second handle which cooperates with the first handle, when a force is applied to the first handle in a first direction, the protrusion slides relative to the second groove around the virtual pivot in the first direction, thus making the first handle and the second handle move apart from each other, meanwhile making the first working part and the second working part move apart from each other; when a force is applied to the first handle in a second direction, the protrusion slides relative to the second groove around the virtual pivot in the second direction, thus making the first handle and the second handle move close to each other, meanwhile making the first working part and the second working part move close to each other; the first direction and the second direction are in the opposite direction to each other.

10. The single-shaft hand tool according to claim 8, wherein the working area has a starting position and an ending position, the starting position is closer to the first groove, the second groove or the protrusion than the ending position, the virtual pivot is at the starting position of the working area.

11. The single-shaft hand tool according to claim 7, wherein the first groove, the second groove and the protrusion all extend in the shape of a circular arc, and the protrusion, the first groove and the second groove are concentric when overlaid with one another.

12. The single-shaft hand tool according to claim 1, wherein the first body is further provided with a first circular hole through the first groove; the second body is provided with a circular arc hole through the second groove, the circular arc hole extends in the shape of a circular arc, and is concentric with the first groove; the protrusion is provided with a second circular hole; a fastener is arranged in the first circular hole, which passes through the second circular hole and the circular arc hole, enabling the first body to be fixedly connected to the second body in the direction parallel to the axis of the virtual pivot.

13. A double-shaft hand tool, comprising a first body and a second body, wherein the first body is pivotally connected to the second body by means of a virtual pivot, the first body is provided with a third groove and a first hole, the second body is provided with a fourth groove and a second hole, a first fastener passes through the first hole and the fourth groove, meanwhile, a second fastener passes through the second hole and the third groove, enabling the first body to be fixedly connected to the second body in the direction parallel to the axis of the virtual pivot.

14. The double-shaft hand tool according to claim 13, wherein the first body has a first working part, the second body has a second working part, and the first working part and the second working part are matched to form a working area.

15. The double-shaft hand tool according to claim 13, wherein the first body has a first handle, the second body has a second handle which cooperates with the first handle, when a force is applied to the first handle in a first direction, the first fastener slides in the fourth groove around the virtual pivot in the first direction, meanwhile the second fastener slides in the third groove around the virtual pivot in a direction opposite to the first direction, thus making the first handle and the second handle move apart from each other, meanwhile making the first working part and the second working part move apart from each other.

16. The double-shaft hand tool according to claim 15, wherein when a force is applied to the first handle in a second direction, the first fastener slides in the fourth groove around the virtual pivot in the second direction, meanwhile the second fastener slides in the third groove around the virtual pivot in a direction opposite to the second direction, thus making the first handle and the second handle move close to each other, meanwhile making the first working part and the second working part move close to each other; the first direction and the second direction are in the opposite direction to each other.

17. The double-shaft hand tool according to claim 15, wherein the working area has a starting position and an ending position, the starting position is closer to the third groove or the fourth groove than the ending position.

18. The double-shaft hand tool according to claim 17, wherein the virtual pivot is at the starting position of the working area.

19. The double-shaft hand tool according to claim 13, wherein the third groove and the fourth groove both extend in the shape of a circular arc, and the third groove and the fourth groove are concentric when overlaid with each other.
